(19) United States
(12) Patent Application Publication
(10) Pub. No.: US 2010/0062953 A1
(43) Pub. Date: Mar. 11, 2010

(54) RHEOLOGY MODIFYING AGENTS AND METHODS OF MODIFYING FLUID RHEOLOGY USE IN HYDROCARBON RECOVERY

(76) Inventors: Janice LoSASSO, Vonore, TN (US); Ashley KRANKOWSKI SCHREINER, Washington, DC (US)

Correspondence Address: HENRY E. BARTONY, JR, BARTONY & ASSOCIATES LLC, P.O. BOX 910, BUTLER, PA, 16003-0910, US

(21) Appl. No.: 12/620,560

(22) Filed: Nov. 17, 2009

Related U.S. Application Data
(63) Continuation of application No. 12/199,858, filed on Aug. 28, 2008.
(60) Provisional application No. 60/966,493, filed on Aug. 28, 2007.

(51) Int. Cl. C09K 8/60; C08G 69/02

(52) U.S. Cl. 507/219; 528/332

(57) ABSTRACT

A method of modifying the rheological properties of a fluid include adding to the fluid at least one polymer that is the reaction product of at least one water soluble, allyic monomer and at least one structure inducing agent. The polymer is adapted to increase the viscosity of the fluid and to impart non-Newtonian characteristic to the fluid. Non-Newtonian characteristics are, for example, evidenced by the fluid exhibiting an n value of less than 1 upon addition of the polymer as determined by the equation τ=Kθⁿ, wherein τ is shear stress, θ is and shear rate and K is a flow consistency index.

### CROSS-REFERENCE TO RELATED APPLICATION

This application is a continuation of U.S. patent application Ser. No. 12/199,858, filed Aug. 28, 2008, which claims benefit of U.S. Provisional Patent Application Ser. No. 60/966,493, filed Aug. 28, 2007, the disclosures of which are incorporated herein by reference.

### BACKGROUND OF THE INVENTION

The present invention relates to rheology modifying agents and to methods of modifying fluid rheology, and particularly to methods of modifying rheology of fluids used in hydrocarbon recovery.

The following information is provided to assist the reader to understand the invention disclosed below and the environment in which it will typically be used. The terms used herein are not intended to be limited to any particular narrow interpretation unless clearly stated otherwise in this document. References set forth herein may facilitate understanding of the present invention or the background of the present invention. The disclosure of all references cited herein are incorporated by reference.

It is known to add various polymeric agents to fluids used in various aspects of recovery of, for example, hydrocarbon fluids from subterranean formation. Aqueous acidic compositions are, for example, used to treat subterranean formations to stimulate the production of hydrocarbons therefrom by acidizing and/or fracturing. Aqueous acidic compositions can, for example, be used to remove undesirable solids to enhance fluid flow into the well bore. Aqueous acidic compositions can also be applied to producing wells to effect fracturing of zones (typically carbonaceous rock such as limestone, calcium carbonate etc.).

Such aqueous acid compositions can be thickened by incorporating a water soluble or water dispersible polymeric viscosifier. See, for example, U.S. Pat. No. 4,690,219. Viscosity, in the broadest sense is a measure of the “thickness” of a fluid and is defined as resistance to flow. Viscosifiers, increase the viscosity of the fluid. Adding a polymeric viscosifier to the acid can, for example, reduce the rate at which the acid and carbonaceous rock interact, thereby enabling the fracture to penetrate deeper into the production zone. Another function of acid viscosifiers is to maintain fluid viscosity as the acid reacts with the rock. If spent acid composition retains its viscosity, it will maintain solids dispersed therein so that the solids do not form bridges, allowing the solids to flow back to the surface without causing damage.

In relatively low concentrations, polymers are also added to acids to reduce pumping pressure by reducing the tendency of the fluid to go into turbulent flow at high flow rates. Maintaining laminar flow is a more efficient flow profile and requires less pump pressure for a given flow rate. This is sometimes referred to as being used as a friction reducer.

Acid compositions typically used in hydrocarbon recovery are 15-28% hydrochloric acid, with some, referred to as mud acid, containing small amounts of hydrofluoric acid. Polymers used for the acidizing process include both natural (for example, xanthan) and synthetic polymers. Typically the polymers are synthetics polymers, such as acrylamide copolymerized with other monomers, and synthetic cationic polymers.

Rheology modifying or fluid flow modifying polymeric agents are also used in rotary drilling processes used for oil, gas and water wells. In those processes, a drilling fluid (mud), which is pumped down the inside of a pipe, exits the pipe through small holes in the bit (jets), and circulates up through the space outside of the pipe (annulus) and back to the surface, where it is cleaned and reused. The term “mud” is derived from the fact that the base viscosifier for many drilling fluids is clay (normally a clay called bentonite, which is known for its ability to disperse into water making a thick slurry). Such fluids operate to cool the bit, carry cuttings out of the hole, control formation pressure, provide lubricity, maintain stability of the drilled formations and transfer energy (in the form of pump pressure) to the bit to enhance the drilling process.

Thickening the mud improves its carrying capacity, but also reduces efficiency of transferring energy from the pump to the face of the drill bit. Properties measured in drilling fluids include, for example, plastic viscosity, which is related to the size, shape and number of particles in the fluid, yield point, which is related to the carrying capacity of the fluid and gel strengths. Such rheological properties provide a measure of how thick the fluid will become over time when motion has stopped. Additionally, a funnel viscosity, or gross thickness, is measured. The funnel viscosity is a measure of how long it takes a quart of the fluid to flow through a precisely sized hole in the bottom of a funnel. Further, in more critical wells, the “n” value, which characterizes the shear thinning property of the fluid, and “k” value, a gross viscosity number at low shear rate, are measured.

A number of additives which “thicken” or viscosify the mud can also improve carrying capacity and suspension of solids. In addition to clay, polymeric thickeners are typically added to further refine the rheological properties. Conditions dictating which polymer(s) are used include salinity, divalent cation content, pH, mud density, and temperature. In general, a polymer that increases suspension characteristics while contributing minimal high shear rate viscosity under dynamic conditions is desirable.

Polymers added to drilling fluids seldom impact just one property. Most contribute to both viscosity and to fluid loss control. Some polymers also assist in maintaining the stability of the hole being drilled. A polymer added to improve suspension and carrying capacity is Xanthan gum. Polymers which contribute to viscosity, but are more typically added for their ability to improve hole stability and fluid loss control include carboxymethylcellulose (CMC or PAC), polyacrylates and polyacrylamides. Other polymers (used, for example, when well conditions preclude polymers such as those described above) are primarily synthetic polymers and typically contain co-monomers designed to impart greater thermal and chemical stability (to, for example, an acrylamide and/or acrylate polymer “backbone”) and/or to improve polymer solubility in high salinity and hardness environments. Such higher performance polymers contribute to viscosity, but also contribute significantly to fluid loss control under extreme conditions.

Polymeric rheology modifying agents are also added to completion fluids used during perforation of well casings. Completion fluids are placed in the casing prior to shooting holes through the casing to prevent uncontrolled fluid flow from the formation to the surface. The completion fluid is typically a brine. Completion fluids can, for example, be thickened to enhance the fluid's ability to suspend solids produced in the completion process. Further, viscosifying the fluid can prevent the brine from flowing into the formations through the perforations.

As with muds, it is often desirable to use fluids that have relatively low viscosity at high shear rates, but good carrying capacity. It is also desirable that the polymers be removable from the perforations to put the well on production. Ideally, the polymers remain soluble and can be degraded or destroyed by acid or enzymes used in the final clean-up of the well to put it on production. Polymers used in completion fluids are hydroxyethylcellulose (HEC) and xanthan gum, and less frequently carboxymethylcellulose and synthetic polymers. As with muds, the type of brine used and the down-hole conditions dictate which polymer is most functional for a specific application.

Polymeric rheology modifying agents are also added to workover fluids. After wells have been on production for some time, various problems can develop. For example, casing perforations may require washing or a pump and/or production tubing may require replacement. To work on the well, a workover fluid is pumped into the hole for essentially the same reasons described above for completion fluids. Typically, the only difference between a workover fluid and a completion fluid is the time in the life of the well when they are used. Such fluids are thus often referred to as workover/completion fluids.

Whether used in connection with acid fluids, muds, completion/workover fluid or other fluids, problems there are substantial limitation associated with both synthetic polymers and the naturally occurring polymers when used as rheology modifying or fluid flow modifying agents in connection with all facets of hydrocarbon recovery. For example, the rheology of commercially available synthetic polymers, such as copolymers of acrylamide, and natural polymers, such as carboxymethylcellulose, lack adequate non-Newtonian character for solids suspension and carrying capacity. Newtonian fluids exhibit a linear change in sheer stress with changing shear rate and a constant viscosity with changing shear rate. To suspend solids, fluids must thicken as shear rate is reduced, i.e. exhibit significant non-Newtonian character. Additionally, both synthetic and natural polymers often exhibit only limited solubility and or functionality as brine density is increased with the addition of inorganic salts. Moreover, although fluids containing xanthan gum polymers exhibit desirable non-Newtonian behavior, such polymers are not stable in at elevated temperature in acid environments and have limited thermal stability in other environments. Typically, synthetic polymers, carboxymethylcellulose, and hydroxymethylcellulose have limited stability at temperatures above 200 F. Further, Xanthan, for example, loses viscosity quickly with increasing temperatures and becomes ineffective at temperatures above 250 F. In addition, Xanthan also loses viscosity and effectiveness quickly with increasing brine concentrations, and becomes completely ineffective in brine concentrations above 15.1 ppg. Further, many synthetic polymers hydrolyze and lose viscosity over time in acidic or high concentration brine environments.

It is thus desirable to develop rheology modifying agents such as viscosifiers for use in hydrocarbon recovery from subterranean deposits that reduce or eliminate one or more of the above-identified problems associated with currently available agents as well as other problems.

### SUMMARY OF THE INVENTION

In one aspect, the present invention provides a method of modifying the rheological properties of a fluid including adding to the fluid at least one polymer that is the reaction product of at least one water soluble, allylic monomer and at least one structure inducing agent. The fluid can, for example, be a hydrocarbon recovery fluid. The polymer is adapted to increase the viscosity of the fluid and to impart non-Newtonian characteristic to the fluid. Non-Newtonian characteristics are, for example, evidenced by the fluid exhibiting an n value of less than 1 upon addition of the polymer as determined by the equation τ=Kθⁿ, wherein τ is shear stress, θ is and shear rate and K is a flow consistency index. For example, such n values can be determined in deionized water using a FAN 35 viscometer at, for example, 75° C. as described further below.

The structure inducing agent is a crosslinking or branching agent. Examples of suitable structure inducing agents include, but are not limited to, polyunsaturated compounds selected from to the group consisting of acrylic amides, polyunsaturated acrylic esters, alkenyl-substituted heterocyclics, tri or tetra-allylic quaternary ammonium or amine compounds and aldehydes. The allylic monomer can, for example, be an allylic quaternary ammonium compound, an allylic amine compound or a salt thereof. The allylic monomer can, for example, be a diallylic monomer. In several embodiments, the diallylic monomer is a diallylic quaternary ammonium compound, a diallylic amine compound or a salt thereof. In a number of preferred embodiments, the diallylic monomer is a diallylic quaternary ammonium compound. In several such embodiments, the diallylic monomer is a diallylic quaternary ammonium halide, a diallylic quaternary ammonium nitrate, a diallylic quaternary ammonium phosphate, a diallylic quaternary ammonium nitrite, a diallylic quaternary ammonium carbonate, a diallylic quaternary ammonium bicarbonate, a diallylic quaternary ammonium sulfate, a diallylic quaternary ammonium sulfite, a diallylic quaternary ammonium borate, or a diallylic quaternary ammonium carboxylate. In a number of embodiments, the diallylic monomer is a diallylic quaternary ammonium halide such as diallylic quaternary ammonium chloride.

Allylic monomers generally have the formula H₂C═CH—CH₂—R. Diallylic monomers generally have the formula (H₂C═CH—CH₂—)₂R²; while triallylic monomers general have the formula (H₂C═CH—CH₂—)₃R³ etc. One or more of the hydrogen groups of the allyl group (H₂C═CH—CH₂—) can be substituted. For example, such hydrogen groups can be substituted (the same or independently and differently) with an alkyl group (for example, a C₁-C₅ alkyl group). In the case of, diallylic quaternary ammonium compounds, R² is —N(R⁴R⁵)—, and the diallylic quaternary ammonium compounds have the general formula:

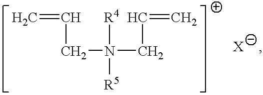

wherein X is an anion. X can, for example, be a halide, a nitrate group, a phosphate group, a nitrite group, a carbonate group, a bicarbonate group, a sulfate group, a sulfite group, a borate group, a carboxylate group or other suitable anion as known in the art. In the case of diallyldimethyl ammonium chloride, for example, R⁴ and R⁵ are methyl groups and X is Cl. Allylic amines have the formula (H₂C═CH—CH₂—)NR⁴R⁵, while diallylic amines have the formula (H₂C═CH—CH₂—)₂NR⁴. Allylamine thus has the formula (H₂C═CH—CH₂—)₂NH₂; while diallyl amine has the formula (H₂C═CH—CH₂—)₂NH. In a number of embodiments, R⁴ and R⁵ are independently, the same or different, H or an alkyl group (for example, a C₁-C₅ alkyl group).

The polymer can, for example, be a reaction product of at least one water soluble allylic monomer and at least one comonomer suitable to undergo radical polymerization. In several embodiments, the allylic monomer is present in at least 5 mole %. The at least one comonomer can, for example, be an amine including at least one unsaturated group. Examples of suitable comonomers include, but are not limited to, at least one of an acrylic amide, a quaternary acrylic ester, a methacrylic ester, n-vinylpyrolidone, vinyl alcohol, a vinyl benzyl quaternary compound, a substituted vinyl benzyl quaternary compound, styrene, substituted styrene, a N-vinylformamide, and/or vinylamine.

In several embodiments of the present invention, the fluid is a field fluid for use in hydrocarbon recovery. The fluid can, for example, be acidic. The fluid can, for example, have a pH of less than 1. In several embodiments, the fluid comprises at least one of HCl or HF. The fluid can, for example, include approximately 1 to 33 Wt % of an acid comprising at least one of HCl or HF.

In a number of embodiments, the fluid has a salinity of greater than 1000 mg/l ionized salts, at least 50,000 mg/l ionized salt, at least 100,000 mg/l ionized salt or even at least 200,000 mg/l ionized salt.

In another aspect, the present invention provides a fluid for use in hydrocarbon recovery including at least one polymer that is the reaction product of at least one water soluble, allyic monomer and at least one structure inducing agent such that the polymer is adapted to increase the viscosity of the fluid and to impart non-Newtonian characteristic to the fluid.

In a further aspect, the present invention provides a hydrophilic polymer that is the reaction product of at least one water soluble, allyic monomer and at least one structure inducing agent such that the polymer is adapted to increase the viscosity of a fluid to which the polymer is added and to impart non-Newtonian characteristic to the fluid.

The polymers of the present invention provides stable rheology modifying agents even at temperature in excess of 275° F. over the entire range of salinity and acidity of filed fluids.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1 sets forth the results of Brookfield rheometer studies for a copolymer of DADMAC and allylamine in a 15 wt % acid solution.

FIG. 2A illustrates rheological Fan 35 data for a 2.5% solution of a copolymer of DADMAC and Allylamine (76/24 mole %) in 11.6 ppg Brine over a temperature range of 75 through 200° F.

FIG. 2B illustrates rheological Fan 35 data for a 2.5% solution of a copolymer of DADMAC and Allylamine (76/24 mole %) in 15.1 ppg Brine over a temperature range of 75 through 200° F.

FIG. 2C illustrates rheological Fan 35 data for a 2.5% solution of a copolymer of DADMAC and Allylamine (76/24 mole %) in a 19.2 ppg Brine over a temperature range of 75 through 200° F.

FIG. 3 illustrates a graphical representation of Brookfield viscosity data as a function of shear rate for a DADMAC homopolymer at various polymer concentrations in DI water, sodium chloride, hydrochloric acid and sea salt.

FIG. 4 illustrates rheological data (as determined in a Brookfield viscometer) for a fluid including 5% of a copolymer of DAMAC/APTAC (95/5 mole %) in a solution of 10.7 lbs/gal of CaCl₂ in deionized water.

FIG. 5 illustrates rheological data (as determined in a Brookfield viscometer) for a fluid including 5%. of a copolymer of DAMAC/NFV (95/5 mole %) in a solution of 10.7 lbs/gal of CaCl₂ in deionized water .

FIG. 6 illustrates rheological Fan 35 data for a 0.5% solution for HEC (hydroxyethylcellulose) in 11.6 ppg brine over a temperature range of 23 through 93.3° C. (which corresponds to 75 through 200° F.

FIG. 7 illustrates rheological Fan 35 data for a 1% solution of HEC and a 0.5% solution of xanthan in 15.1 ppg brine over a temperature range of 75 through 200° F.

FIG. 8 illustrates rheological Fan 35 data for a 1% solution of HEC in a 19.2 ppg brine over a temperature range of 75 through 200° F. (Xanthan produced no viscosity modification in the 19.2 ppg brine.)

FIG. 9A illustrates the temperature dependence of DADMAC/Allylamine copolymer at a constant sheer rate of 200 sec⁻¹ in 11.6 brine.

FIG. 9B illustrates the temperature dependence of HEC at a constant sheer rate of 200 sec⁻¹ in 11.6 brine.

FIG. 10A illustrates the temperature dependence of DADMAC/Allylamine copolymer at a constant sheer rate of 200 sec⁻¹ in 15.1 ppg brine.

FIG. 10B illustrates the temperature dependence of HEC at a constant sheer rate of 200 sec⁻¹ in 15.1 ppg brine.

FIG. 10C illustrates the temperature dependence of xanthan at a constant sheer rate of 200 sec⁻¹ in 15.1 ppg brine.

FIG. 11A illustrates the temperature dependence DADMAC/allylamine copolymer in 19.2 ppg brine.

FIG. 11B illustrates the temperature dependence of HEC in 19.2 ppg brine.

### DETAILED DESCRIPTION OF THE INVENTION

In several embodiments, the present invention provides polymers formed from monomers including water soluble allylic organic monomers. The allylic organic monomer can, for example, include allylic quaternary ammonium compounds (for example, halides, nitrates, phosphates, nitrites, carbonates, bicarbonates, sulfates, sulfites, borates, carboxylates etc). In several representative embodiment, diallylic quaternary ammonium halides including, but not limited to, diallyldimethylammonium chloride or DADMAC were used. Other suitable water soluble allylic monomers include allylic amines and their salts (for example, halides, nitrates, phosphates, nitrites, carbonates, bicarbonates, sulfates, sulfites, borates, carboxylates etc).

PolyDAMCAC (poly(diallyldimethylammonium chloride)) is, for example, a unique cationic polymer that is very soluble in brine and is also stable at high temperatures which are prevalent in drilling applications. Further polyDADMAC is also very soluble and stable in acid environments. Although polyDADMAC thus exhibits several characteristics that are desirable in rheology modifying agents as described above, currently available polyDADMAC polymers exhibit Newtonian rheological behavior in water and in brine as a result of relatively low molecular weights. Further, currently available polyDADMAC polymers and copolymers cannot achieve sufficient viscosity levels at any concentration to allow such polymers to function as thickening or viscosifying applications in hydrocarbon recovery. In the case of acid viscosifying agents, for example, viscosity increase of 100 fold or more can be desirable.

In several representative studies of the present invention, a series of polyDADMAC homopolymers and copolymers that were highly branched and potentially partially crosslinked (that is, to a degree such that the polymers remained at least partially water soluble or water miscible—that is, water soluble or water miscible to a degree such that the polymers were able to increase the viscosity of the water, including brines and acids,) were synthesized and characterized. The polymers exhibited sufficiently high molecular weight to achieve viscosity levels necessary for fluid thickening or viscosifying applications. The polymers were sufficiently soluble or miscible in high salinity solutions, including brine, and in acid solution (for example, 15 and 28% HCL acid solutions) to achieve desired viscosity levels for thickening applications, for example, in hydrocarbon recovery. Moreover, the polymers were suitably stable and maintain non-Newtonian, shear thinning characteristics and viscosity both in high temperature environments and in acidic environments (for example, 15 and 28% HCL acid solutions). In addition, the polymers of the present invention can be formulated to be relatively environmentally friendly. For example, the polymers can be formulated to be free of potentially environmentally hazardous acrylamides, which are used in many currently available viscosifying compositions.

The term “salinity” has been defined in a number of manners over the last century. See, for example, U.S. Patent Application Publication No. 2005/019,415 (Ser. No. 11/065,806), the disclosure of which is incorporated herein by reference.

Fresh water typically has a salinity of well less that 1 ppt (or 1000 parts per million, ppm) (as, for example, determined using The Practical Salinity Scale of 1978). See, for example, Stewart, R. H, Introduction to Physical Oceanography, Department of Oceanography, Texas A & M University, Chapter 6 (August 2003 edition). OK Indeed, the salinity of fresh water varies widely, but is typically less than 0.5 ppt. On the other hand, seawater typically has a salinity in the range of approximately 20 to 40 ppt, with an average salinity of approximately 35 ppt. The term “fresh water” is often used in connection with water having a salinity less 0.5 ppt; the term “brackish water” is often used in connection with water having a salinity in the range of 0.5 to 30 ppt; the term “saline water” is often used in connection with water having a salinity in the range of 30 to 50 ppt; and the term “brine” is used in connection with water having a salinity greater than 50 ppt. Brine can be saturated with or nearly saturated with dissolved solids or salts. The compositions of the present invention are suitable for use in aqueous fluids having a salinity greater than 0.5, greater than 1, greater than, 3, greater than 10, greater than 35 and even greater than 50 ppt.

In oilfield work, a more general description of salinity is commonly used. Typically oil field fluids range from fresh water, containing less than 1000 mg/l ionized salts, to high density brines containing varying concentrations of salts, either singularly or mixtures thereof, such as sodium chloride, sodium bromide, potassium chloride, calcium bromide, calcium chloride, zinc bromide, zinc chloride and cesium formate. The density of field brines, described as Specific Gravity (SG), of these fluids ranges from 1.0 for fresh water to has high as 2.6 for the very high concentration brines. As the density and salinity increase, the fluids become more difficult to viscosify. In general, field brines are aqueous fluids produced from a single well or a mixture of aqueous fluids from multiple wells. The fluid will contain a largely undefined mixture of salts with salinity potential to range from fresh water to salinities in excess of 400,000 mg/l. In addition to salts the fluid may contain small quantities of acid gases, such as hydrogen sulfide and carbon dioxide, and trace amounts of hydrocarbon. The compositions of the present invention are suitable for use in connection with field brines over the entire range of salinity thereof (for example, salinities of at least 50,000 mg/l ionized salt, at least 100,000 mg/l ionized salt, at least 200,000 mg/l ionized salt, or even at least 400,000 mg/l ionized salt, or even at least 800,000 mg/l).

As used herein, the terms “branched,” “branching” and related terms refer to the creation of branches or additional termini relative to the two original termini that exist in linear entities.

The term “branching agent” refers to an agent which causes branching to occur.

The term “copolymer” refers to a polymer including two or more dissimilar repeat units (including terpolymers—comprising three dissimilar repeat units, interpolymers—comprising four or more dissimilar repeat units—etc.).

The term “cross-link” refers to an interconnection between polymer chains.

The term “cross-linking agent” refers to an agent which induces cross-linking, branching or a combination thereof to occur.

The term “unsaturated” refers to the presence of at least one unsaturated or carbon-carbon double bond (C═C) group.

The term “monomer” refers to single, discreet molecule which is capable of combining to form polymers.

The term “polymer” refers to a compound having multiple repeat units (or monomer units) and includes copolymers (including two, three, four or more monomers).

The term “structured polymer” refers to a polymer prepared with incorporation of a structure-inducing agent.

The term “structure-inducing agent” refers to an agent which, when added to a polymer composition, induces branching, cross-linking or a combination thereof.

In view of the above definitions, other terms of chemical and polymer technology used throughout this application can be easily understood by those of skill in the art. Terms may be used alone or in any combination thereof.

The polymers of the present invention can be prepared by conventional polymerization techniques well-known to those skilled in the art. Such techniques include, but are not limited to, solution polymerization, reverse-phase emulsion polymerization, precipitation polymerization and suspension polymerization. Polymerization may be initiated via a free radical initiator. The preferred initiator method is free radical, however, photochemical or radiation methods may also be utilized. The introduction of the structure-inducing agent may be performed either prior to, concurrent with or after combining the other agents necessary for formation of the structured polymers of this invention.

Although molecular weight can be difficult to measure in crosslinked polymers, the polymer compositions of the present invention have a molecular weight of at least 500,000, at least 750,000 and even at least 1,000,000. In general, concentrations of structure inducing agent of at least 0.05 mole % were used in synthesizing the polymers of the present invention.

In a number of embodiments of the present invention, unsaturated quaternary ammonium halide monomer(s) were polymerized alone or with other unsaturated monomers in the presence of a structure inducing agent to produce water soluble polymers. Several representative studies of such polymers are set forth below.

The following examples are for the purposes of illustration and are not to be construed as limiting the scope of the invention in any way.

### EXPERIMENTAL EXAMPLES

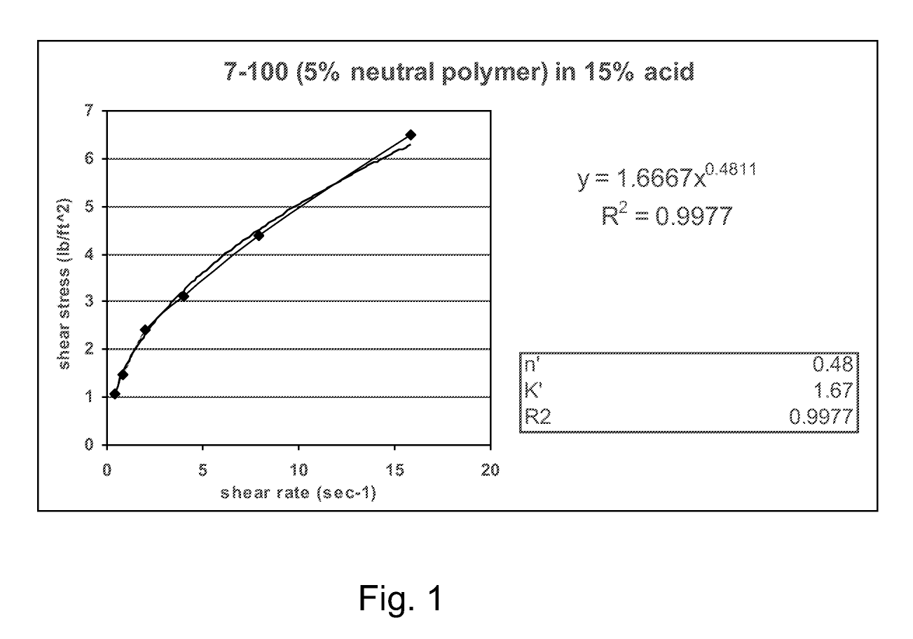

Acidic Environments. Table 1A sets forth the results of viscosity studies for a polyDADMAC homopolymer, a copolymer of DADMAC and n-vinylformamide (NVF), and a copolymer of DADMAC and acrylamidopropyltrimethylammonium chloride (APTAC) in deionized water having a weight percent acid as indicated. In general, in the case of copolymers of the present invention, the weight percentages of the comonomers used in preparing the copolymer are provided in parenthesis following the copolymer designation. Thus, the copolymer DADMAC/NVF (95/5 mole %) was prepared with 95 mole % DADMAC and 5 mole % NVF. Table 1B and FIG. 1A set forth the results of Brookfield rheometer studies of a copolymer of DADMAC and allylamine. As illustrated, for example, in FIG. 1A, the copolymer exhibits typical shear-thinning, non-Newtonian behavior.

TABLE 1A

| | Poly. Conc. | % Acid | Viscosity |
|---|---|---|---|
| Polymer | (mole %) | (wt %) | (cP) |
| DADMAC | 5 | 28 | 97.5 |
| Homopolymer | | | |
| DADMAC/NVF | 5 | 15 | 5934 |
| (95/5 mole %) | | | |
| DADMAC/APTAC | 5 | 15 | 148.5 |
| (95/5 mole %) | | | |

TABLE 1B
DADMAC/Allylamine (76/24 mole %)
Experiment: 5% neutralized polymer in 15% HCl
pH = 0
Spindle 18

| | | | | | Shear | |
|---|---|---|---|---|---|---|
| | shear | | | | Stress | Shear |
| Speed | rate | % | Spindle | Viscosity | (dynes/ | Stress |
| (rpm) | (sec⁻¹) | Torque | Factor | (P) | cm²) | (lb/ft²) |
| 0.3 | 0.396 | 13 | 100 | 1300 | 514.8 | 1.0754172 |
| 0.6 | 0.792 | 17.8 | 50 | 890 | 704.88 | 1.47249432 |
| 1.5 | 1.98 | 29.1 | 20 | 582 | 1152.36 | 2.40728004 |
| 3 | 3.96 | 37.6 | 10 | 376 | 1488.96 | 3.11043744 |
| 6 | 7.92 | 52.9 | 5 | 264.5 | 2094.84 | 4.37612076 |
| 12 | 15.84 | 78.7 | 2.5 | 196.75 | 3116.52 | 6.51041028 |

Once again, the subject polymers exhibit typical shear-thinning, non-Newtonian behavior. Shear thinning, non-Newtonian behavior can be quantified by the “n” factor as described by the Power Law Model, which is often set forth as τ=Kθⁿ, wherein τ is shear stress, θ is and shear rate and K is a flow consistency index as described further below. The “n” factor indicates the degree of non-Newtonian behavior that a fluid exhibits over a defined shear rate range. Fluids which are Newtonian, such as water and glycerin, have an “n” factor of 1.0 and theory predicts, as practice has shown, that such fluids have poor hole-cleaning characteristics when used in hydrocarbon recover. As the “n” value decreases from 1.0, the fluid becomes more non-Newtonian and the ability to clean the hole and suspend solids increases. As the “n” value represents the change in shear rate/shear stress ratio with changing shear rate, it is a dimensionless value.

The second value defined by the Power Law Model, and reported in the studies of the present invention, is “K” which is a consistency index or actual viscosity at one reciprocal second shear rate. The number relates to resistance to flow and therefore is related to a reduction in the rate at which solids will fall through the fluid,. The K value can further be related to the amount of energy required to pump the fluid. The K value can, for example, be reported in dynes-sec/cm².

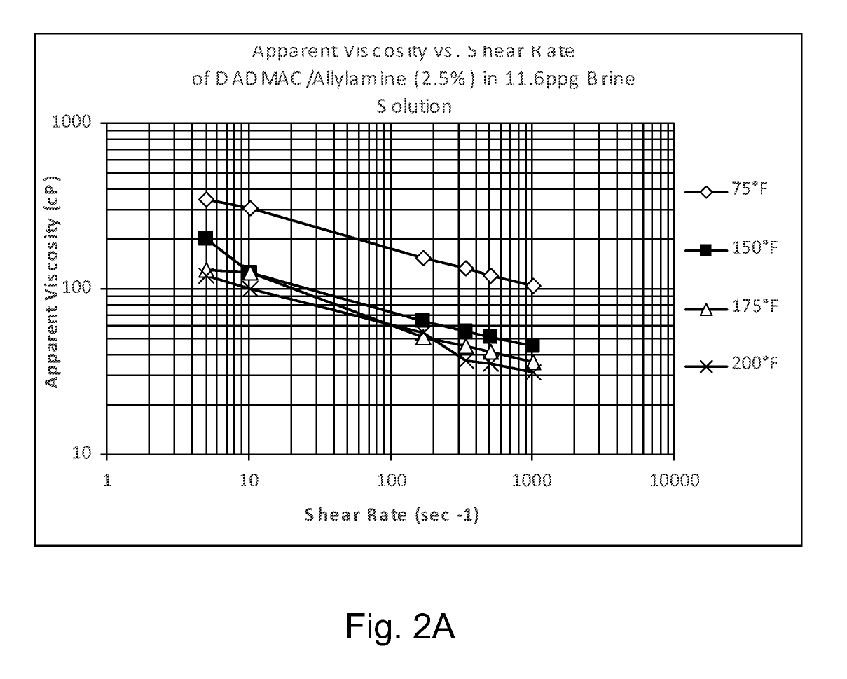

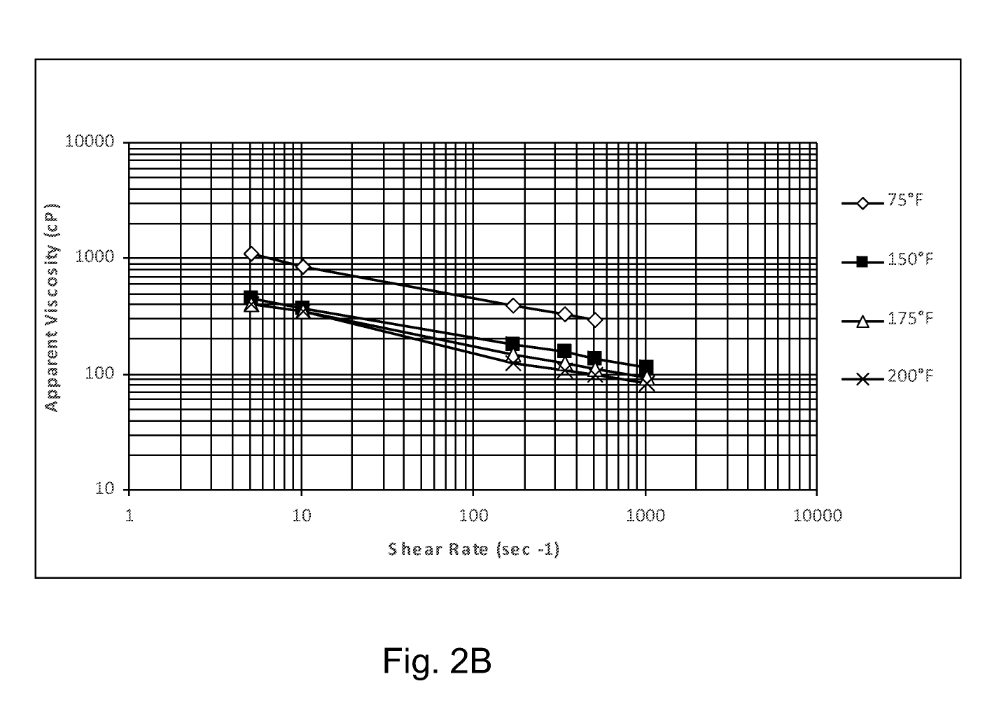

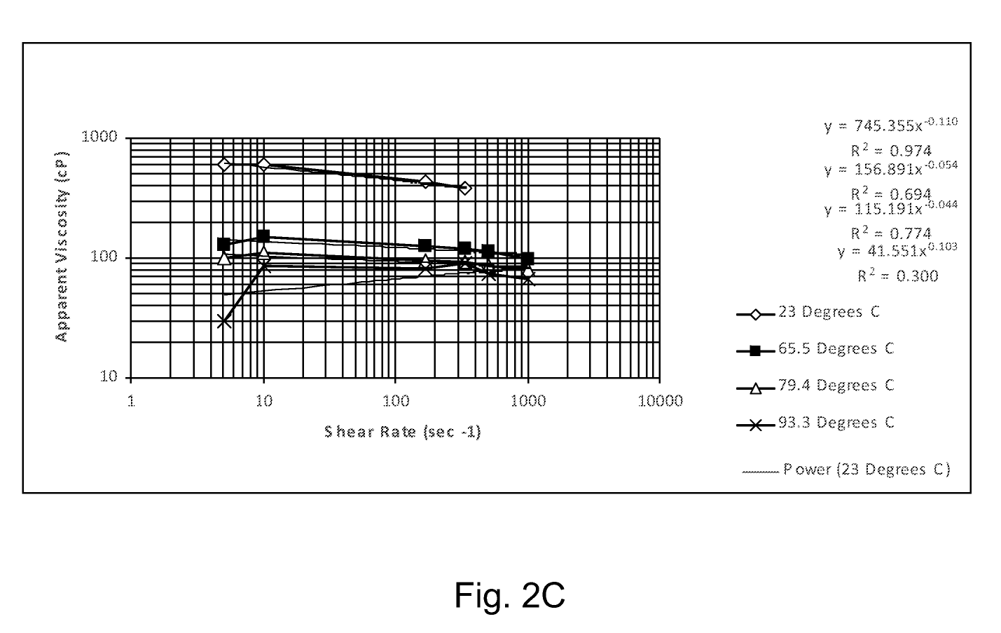

High Temperature and Brine Environments. Tables 2A through 2C below and corresponding FIGS. 2A through 2C set forth rheological data (from a Fann 35 Viscometer) for a 2.5% solution of a copolymer of DADMAC/Allylamine (76/24 mole %) in 11.6 ppg Calcium chloride brine, 15.1 ppg Calcium bromide brine and 19.2 ppg Zinc Bromide brines respectively over a temperature range of 75 F to 200 F. Tables 3A through 3C, also below, set forth rheological data (from a Fann 35 Viscometer) for a 2% solution of a DADMAC homopolymer in 11.6 calcium chloride brine, 14.2 ppg calcium bromide brine and 19.2 ppg zinc bromide brines respectively. The data shown in the tables and illustrated in the figures illustrates the ability of both the homopolymer and copolymer to maintain both viscosity and non-Newtonian sheer thinning capability along with suspending capability (n value less than 1) regardless of temperature, brine type or brine concentration over the studies brine concentrations and temperatures. PolyDADMAC is well known for its stability at temperatures higher than those shown in this study. A computer extrapolation of viscosity at higher temperatures, indicates that the viscosity of the DADMAC homopolymer at 300 rpm, sheer rate 113, 2% solution in 11.6 calcium chloride brine, 14.1 calcium bromide brine and 19.2 zinc bromide brine is stable to 350F. This data is set forth in Table 3D. The designation “ppg” refers to density and is an abbreviation for pounds per gallon. The 11.6 ppg brine solution is a 40% solution of calcium chloride. The 15.1 ppg brine solution contains 42.3% calcium bromide and 18.5% calcium chloride, and provides a brine solution concentration 61.1%. The 19.2 ppg brine solution contains 52.8% zinc bromide and 22.8% calcium bromide, providing a brine solution concentration 85.6%. A solution concentration of 85.6% brine is equivalent to 856,000 g/L brine.

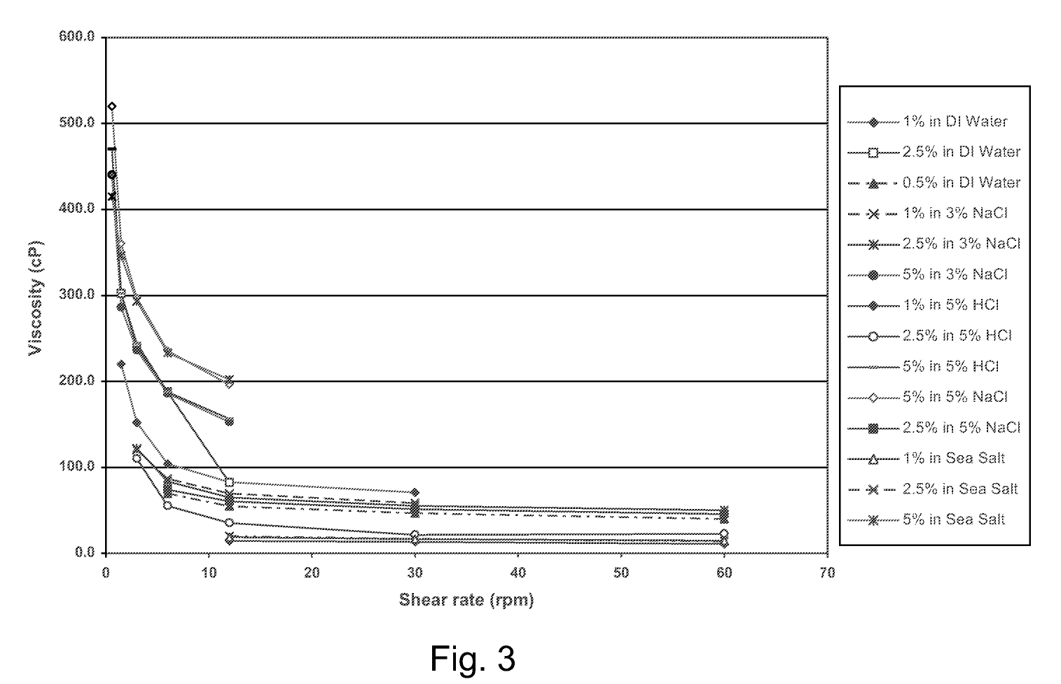

Tables 3E through 3R and corresponding FIG. 3 illustrate that a representative example of DADMAC homopolymer has the ability to thicken solutions of various chemical entities (as found, for example, in oil fields—including sodium chloride, hydrochloric acid and sea salt) while imparting non-Newtonian behavior to such solutions.

TABLE 2A
2.5% sol. DADMAC/Allylamine in 11.6 Brine

Viscosity (cP) at Temperatures (F.)

| RPM | Shear Rate | 75 | 150 | 175 | 200 |
|---|---|---|---|---|---|
| 3 | 5.1 | 350 | 200 | 130 | 120 |
| 6 | 10.2 | 305 | 125 | 125 | 100 |
| 100 | 170 | 154.5 | 64.5 | 51 | 54 |
| 200 | 340 | 132 | 55.5 | 45 | 37.2 |
| 300 | 511 | 120.5 | 51 | 41.5 | 35.7 |
| 600 | 1021 | 105.1 | 45.5 | 36 | 31.05 |

TABLE 2B
2.5% DADMAC/Allylamine Copolymer Solution in 15.1 ppg Brine

Viscosity (cP) at Temperature (F.)

| RPM | Shear Rate | 75 | 150 | 175 | 200 |
|---|---|---|---|---|---|
| 3 | 5.1 | 1100 | 450 | 400 | 400 |
| 6 | 10.2 | 850 | 375 | 350 | 350 |
| 100 | 170 | 387 | 183 | 147 | 126 |
| 200 | 340 | 331.5 | 154.5 | 123 | 106.5 |
| 300 | 511 | 298 | 134 | 110 | 98 |
| 600 | 1021 | 0 | 113 | 93.5 | 82.5 |

TABLE 2C
2.5% DADMAC/Allylamine Solution in 19.2 ppg Brine

Viscosity (cP) at
Temperature (F.)

| RPM | Shear Rate | 75 | 150 | 175 | 200 |
|---|---|---|---|---|---|
| | 1 | | | | |
| 3 | 5.1 | 600 | 130 | 100 | 30 |
| 6 | 10.2 | 600 | 150 | 110 | 85 |
| 100 | 170 | 432.9 | 126 | 95.4 | 81.6 |
| 200 | 340 | 381.3 | 120 | 91.8 | 90.3 |
| 300 | 511 | 0 | 113 | 87 | 74 |
| 600 | 1021 | 0 | 98.4 | 80.1 | 66.25 |

TABLE 3A
2% Solution DADMAC Homopolymer in 11.6 ppg CaCl2 Brine

| | Sheer | Visc. vs. Temperature in Deg. F | | | | |
|---|---|---|---|---|---|---|
| RPM | Rate | 75 F. | 125 F. | 150 F. | 175 F. | 200 F. |
| 3 | 1 | 1097 | 731 | 548 | 378 | 365 |
| 6 | 2 | 874 | 524 | 437 | 350 | 345 |
| 100 | 38 | 357 | 202 | 160 | 128 | 106 |
| 300 | 113 | 286 | 146 | 118 | 87 | 72 |
| 600 | 226 | 229 | 116 | 102 | 65 | 53 |
| N′ | | 0.7546 | 0.6851 | 0.6580 | 0.6242 | 0.6134 |

TABLE 3B
2% Solution DADMAC Homopolymer in 14.2 CaBr2 Brine

| | Sheer | Visc. vs. Temperature in Deg. F. | | | | |
|---|---|---|---|---|---|---|
| RPM | Rate | 75 F. | 125 F. | 150 F. | 175 F. | 200 F. |
| 3 | 1 | 6120 | 6098 | 3656 | 3170 | 2742 |
| 6 | 2 | 5484 | 3934 | 3060 | 2842 | 2185 |
| 100 | 38 | 1680 | 1013 | 720 | 560 | 453 |
| 200 | 75 | 1520 | 840 | 573 | 453 | 373 |
| 300 | 113 | 1237 | 720 | 516 | 391 | 320 |
| 600 | 226 | 974 | 547 | 387 | 302 | 240 |
| N′ | | 0.6857 | 0.6542 | 0.6575 | 0.6552 | 0.6442 |

TABLE 3C
2% Solution DADMAC Homopolymer in 19.2 ZnBr2 Brine

| | Sheer | Visc. vs. Temperature in Deg. F | | | | |
|---|---|---|---|---|---|---|
| RPM | Rate | 75 F. | 125 F. | 150 F. | 175 F. | 200 F. |
| 3 | 1 | 9141 | 4570 | 3656 | 2742 | 2620 |
| 6 | 2 | 6557 | 3934 | 2623 | 2185 | 2066 |
| 100 | 38 | 2774 | 1386 | 1066 | 853 | 640 |
| 200 | 75 | 2293 | 1187 | 880 | 693 | 547 |
| 300 | 113 | 2046 | 1059 | 800 | 613 | 498 |
| 600 | 226 | 1987 | 814 | 605 | 476 | 364 |
| N′ | | 0.8367 | 0.7445 | 0.7610 | 0.7066 | 0.7050 |

TABLE 3D
High Temperature Extrapolation Data - Fann 300 rpm, sheer rate 113

| Brine | | | | | | | | |
|---|---|---|---|---|---|---|---|---|
| ppg | 75 | 125 | 150 | 175 | 200 | 250 | 300 | 350 |
| 11.6 | 286 | 146 | 118 | 87 | 72 | 55 | 48 | 42 |
| 14.2 | 1237 | 720 | 516 | 391 | 320 | 245 | 190 | 157 |
| 19.2 | 2046 | 1059 | 800 | 613 | 498 | 210 | 180 | 140 |

TABLE 3E
1% in DI Water
Brookfield LV DV-E Viscometer
Spindle s18

| Speed (rpm) | % Torque | Viscosity (cP) |
|---|---|---|
| 1.5 | 11.0 | 220.0 |
| 3 | 15.2 | 152.0 |
| 6 | 20.8 | 104.0 |
| 12 | 33.1 | 82.8 |
| 30 | 70.7 | 70.7 |

TABLE 3F
2.5% in DI Water
Brookfield LV DV-E Viscometer
Spindle s18

| Speed (rpm) | % Torque | Viscosity (cP) |
|---|---|---|
| 1.5 | 15.1 | 302.0 |
| 3 | 24.0 | 240.0 |
| 6 | 37.5 | 187.5 |
| 12 | 32.8 | 82.0 |

TABLE 3G
0.5% in DI Water
Brookfield LV DV-E Viscometer
Spindle s18

| Speed (rpm) | % Torque | Viscosity (cP) |
|---|---|---|
| 6 | 13.9 | 69.5 |
| 12 | 21.9 | 54.8 |
| 30 | 46.5 | 46.5 |
| 60 | 79.5 | 39.8 |

TABLE 3H
1% in 3% NaCl
Brookfield LV DV-E Viscometer
Spindle s18

| Speed (rpm) | % Torque | Viscosity (cP) |
|---|---|---|
| 12 | 8.0 | 20.0 |
| 30 | 16.6 | 16.6 |
| 60 | 28.1 | 14.1 |

TABLE 3I
2.5% in 3% NaCl
Brookfield LV DV-E Viscometer
Spindle s18

| Speed (rpm) | % Torque | Viscosity (cP) |
|---|---|---|
| 3 | 12.2 | 122.0 |
| 6 | 16.7 | 83.5 |
| 12 | 25.9 | 64.8 |
| 30 | 55.0 | 55.0 |
| 60 | 100.0 | 50.0 |

TABLE 3J
5% in 3% NaCl
Brookfield LV DV-E Viscometer
Spindle s18

| Speed (rpm) | % Torque | Viscosity (cP) |
|---|---|---|
| 0.6 | 8.8 | 440.0 |
| 1.5 | 14.3 | 286.0 |
| 3 | 23.6 | 236.0 |
| 6 | 37.2 | 186.0 |
| 12 | 61.0 | 152.5 |

TABLE 3K
2.5% in 5% NaCl
Brookfield LV DV-E Viscometer
Spindle s18

| Speed (rpm) | % Torque | Viscosity (cP) |
|---|---|---|
| 6 | 14.8 | 74.0 |
| 12 | 24.1 | 60.3 |
| 30 | 51.2 | 51.2 |
| 60 | 90.9 | 45.5 |

TABLE 3L
5% in 5% NaCl
Brookfield LV DV-E Viscometer
Spindle s18

| Speed (rpm) | % Torque | Viscosity (cP) |
|---|---|---|
| 0.6 | 10.4 | 520.0 |
| 1.5 | 18.0 | 360.0 |
| 3 | 29.7 | 297.0 |
| 6 | 47.1 | 235.5 |
| 12 | 78.4 | 196.0 |

TABLE 3M
1% in 5% HCl
Brookfield LV DV-E Viscometer
Spindle s18

| Speed (rpm) | % Torque | Viscosity (cP) |
|---|---|---|
| 12 | 5.7 | 14.3 |
| 30 | 13.2 | 13.2 |
| 60 | 21.4 | 10.7 |

TABLE 3N
2.5% in 5% HCl
Brookfield LV DV-E Viscometer
Spindle s18

| Speed (rpm) | % Torque | Viscosity (cP) |
|---|---|---|
| 3 | 11.0 | 110.0 |
| 6 | 14.1 | 55.0 |
| 12 | 21.3 | 35.3 |
| 30 | 45.2 | 21.3 |
| 60 | 84.1 | 22.6 |

TABLE 3O
5% in 5% HCl
Brookfield LV DV-E Viscometer
Spindle s18

| Speed (rpm) | % Torque | Viscosity (cP) |
|---|---|---|
| 0.6 | 9.4 | 470.0 |
| 1.5 | 15.1 | 302.0 |
| 3 | 24.4 | 244.0 |
| 6 | 37.5 | 187.5 |
| 12 | 62.5 | 156.3 |

TABLE 3P
1% in Sea Salt
Brookfield LV DV-E Viscometer
Spindle s18

| Speed (rpm) | % Torque | Viscosity (cP) |
|---|---|---|
| 12 | 7.5 | 18.8 |
| 30 | 16.4 | 16.4 |
| 60 | 29.1 | 14.6 |

TABLE 3Q
2.5% in Sea Salt
Brookfield LV DV-E Viscometer
Spindle s18

| Speed (rpm) | % Torque | Viscosity (cP) |
|---|---|---|
| 3 | 12.0 | 120.0 |
| 6 | 17.3 | 86.5 |
| 12 | 27.8 | 69.5 |
| 30 | 58.4 | 58.4 |

TABLE 3R
5% in Sea Salt
Brookfield LV DV-E Viscometer
Spindle s18

| Speed (rpm) | % Torque | Viscosity (cP) |
|---|---|---|
| 0.6 | 8.3 | 415.0 |
| 1.5 | 17.3 | 346.0 |
| 3 | 29.3 | 293.0 |
| 6 | 46.6 | 233.0 |
| 12 | 80.8 | 202.0 |

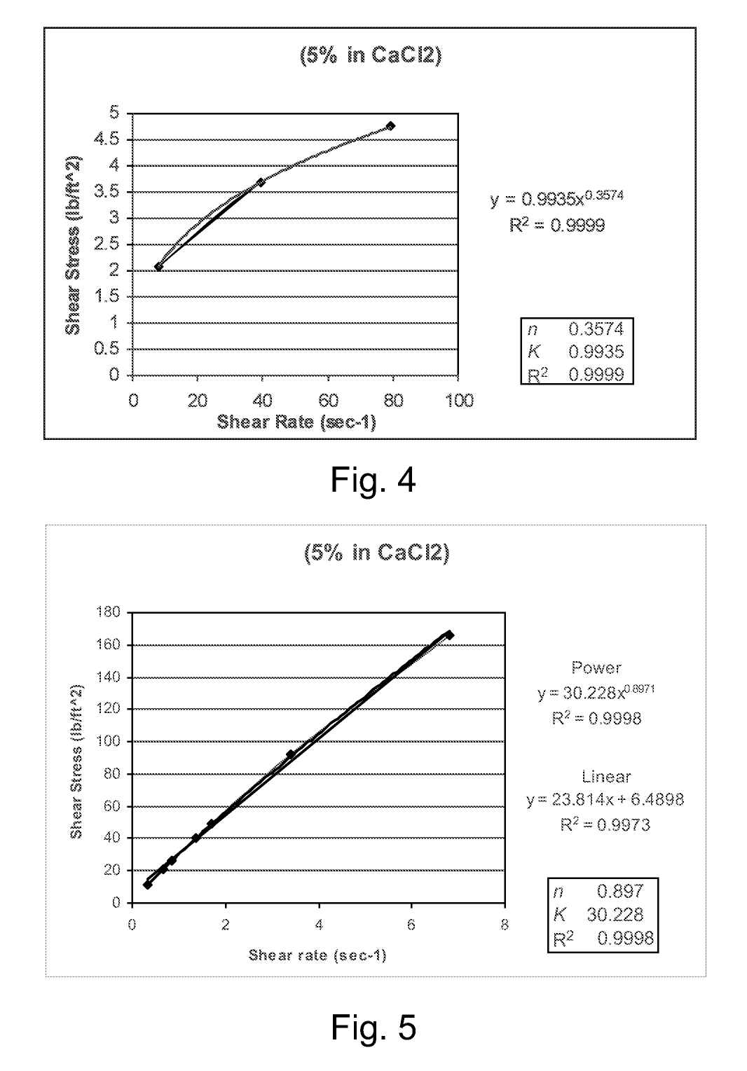

The rheological data (Brookfield) set forth in Tables 4 and 5 below and illustrated in FIGS. 4 and 5 demonstrates the sheer thinning behavior of a 5% solution of a DADMAC/APTAC and a 5% solution of a DADMAC/n-vinylformamide copolymer respectively in a 10.7 ppg calcium chloride brine at 75 F.

TABLE 4
95/5 DADMAC/APTAC
Experiment: 5%
Spindle 18
10.7ppg CaCl₂

| | shear | | | | | |
|---|---|---|---|---|---|---|
| | rate | | Spindle | | Shear Stress | Shear Stress |
| Speed (rpm) | (sec⁻¹) | % Torque | Factor | Viscosity (P) | (dynes/cm²) | (lb/ft²) |
| 6 | 7.92 | 25.2 | 5 | 126 | 997.92 | 2.08465488 |
| 30 | 39.6 | 44.5 | 1 | 44.5 | 1762.2 | 3.6812358 |
| 60 | 79.2 | 57.5 | 0.5 | 28.75 | 2277 | 4.756653 |

TABLE 5
95/5 DADMAC/NVF
Experiment: 5%
Spindle 27
10.7ppg CaCl₂

| | shear | | | | | |
|---|---|---|---|---|---|---|
| | rate | | Spindle | | Shear Stress | Shear Stress |
| Speed (rpm) | (sec⁻¹) | % Torque | Factor | Viscosity (P) | (dynes/cm²) | (lb/ft²) |
| 1 | 0.34 | 6.4 | 2500 | 16000 | 5440 | 11.36416 |
| 2 | 0.68 | 12.1 | 1250 | 15125 | 10285 | 21.485365 |
| 2.5 | 0.85 | 14.7 | 1000 | 14700 | 12495 | 26.102055 |
| 4 | 1.36 | 22.5 | 625 | 14062.5 | 19125 | 39.952125 |
| 5 | 1.7 | 27.5 | 500 | 13750 | 23375 | 48.830375 |
| 10 | 3.4 | 52 | 250 | 13000 | 44200 | 92.3338 |
| 20 | 6.8 | 93.3 | 125 | 11662.5 | 79305 | 165.668145 |

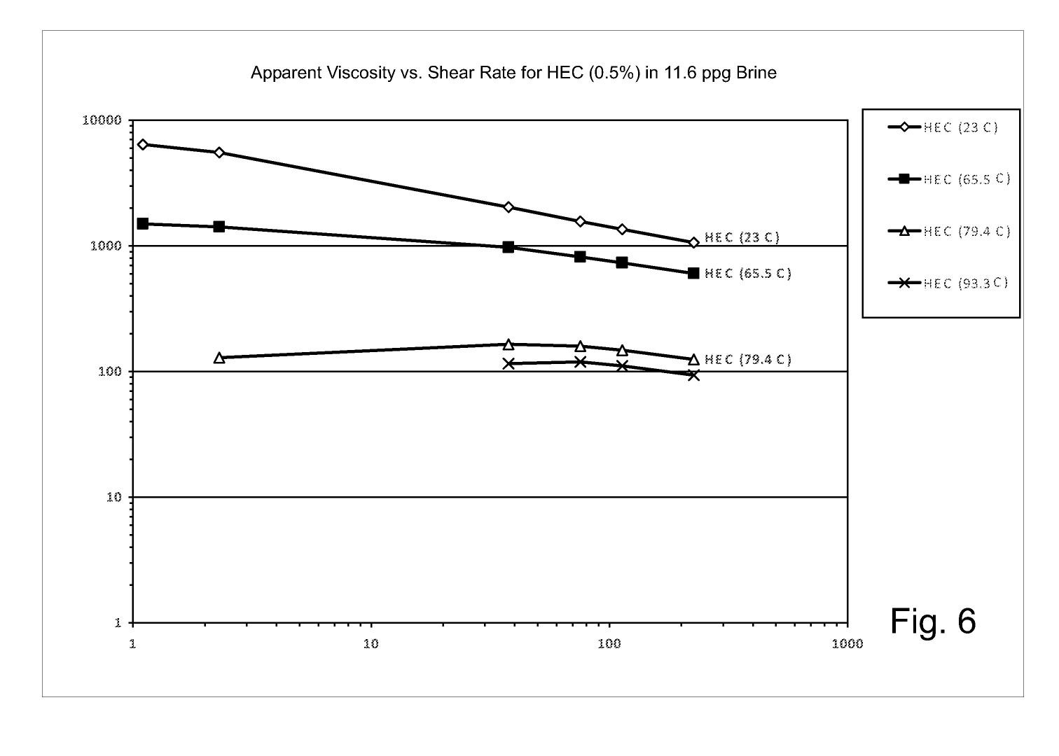

Tables 6 through 8 below and corresponding FIGS. 6 through 8 set forth comparative data for solutions of HEC and xanthan, both of which are currently used as rheology modifiers in hydrocarbon recovery processes. The data set forth set forth in Table 6 and the illustration of that data in FIG. 6 shows the viscosity versus sheer relationship (using a Fan 35 viscometer) of a 0.5% solution of HEC in 11.6 ppg brine over a temperature range of 75° F. through 200° F. As illustrated, at a temperature of 175° F. the HEC began to lose it's sheer thinning characteristics, and at 200° F., the viscosity at low sheer rates was too low to measure using the Fan 35 viscometer. This behavior is particularly significant in that, for the hydrocarbon recovery applications described previously, it is necessary to maintain viscosity as sheer rates approach 0 to, for example, be able to suspend and remove cuttings from the well. The inability to do so will prevent significant loss of fluids to the formation.

TABLE 6

| | | | | |
|---|---|---|---|---|
| | Shear | | Shear | |
| | Rate | | Stress | Apparent |
| R₁/B2 | sec⁻¹ | Reading | lb_{f}/ft² | Viscosity |

HEC 0.5%
Room Temperature (75 deg F.)

| | | | | |
|---|---|---|---|---|
| 3 | 1.10 | 30 | 0.3198 | 6407.7170 |
| 6 | 2.30 | 43 | 0.4584 | 5537.3073 |
| 100 | 37.70 | 123 | 1.3112 | 2031.3544 |
| 200 | 75.40 | 157 | 1.6736 | 1563.2496 |
| 300 | 113.00 | 183 | 1.9508 | 1355.2929 |
| 600 | 226.00 | 238 | 2.5371 | 1062.6913 |

150 deg F.

| | | | | |
|---|---|---|---|---|
| 3 | 1.10 | 7 | 0.0746 | 1495.1340 |
| 6 | 2.30 | 11 | 0.1173 | 1416.5205 |
| 100 | 37.70 | 59 | 0.6289 | 974.3895 |
| 200 | 75.40 | 82 | 0.8741 | 816.4743 |
| 300 | 113.00 | 99 | 1.0553 | 733.1912 |
| 600 | 226.00 | 135 | 1.4391 | 602.7871 |

175 deg F.

| | | | | |
|---|---|---|---|---|
| 3 | 1.10 | 0 | 0.0000 | 0.0000 |
| 6 | 2.30 | 1 | 0.0107 | 128.7746 |
| 100 | 37.70 | 10 | 0.1066 | 165.1508 |
| 200 | 75.40 | 16 | 0.1706 | 159.3121 |
| 300 | 113.00 | 20 | 0.2132 | 148.1194 |
| 600 | 226.00 | 28 | 0.2985 | 125.0225 |

200 deg F.

| | | | | |
|---|---|---|---|---|
| 3 | 1.10 | 0 | 0.0000 | 0.0000 |
| 6 | 2.30 | 1 | 0.0210 | 128.7746 |
| 100 | 37.70 | 7 | 0.1470 | 115.6055 |
| 200 | 75.40 | 12 | 0.2520 | 119.4840 |
| 300 | 113.00 | 15 | 0.3150 | 111.0896 |
| 600 | 226.00 | 21 | 0.4410 | 93.7669 |

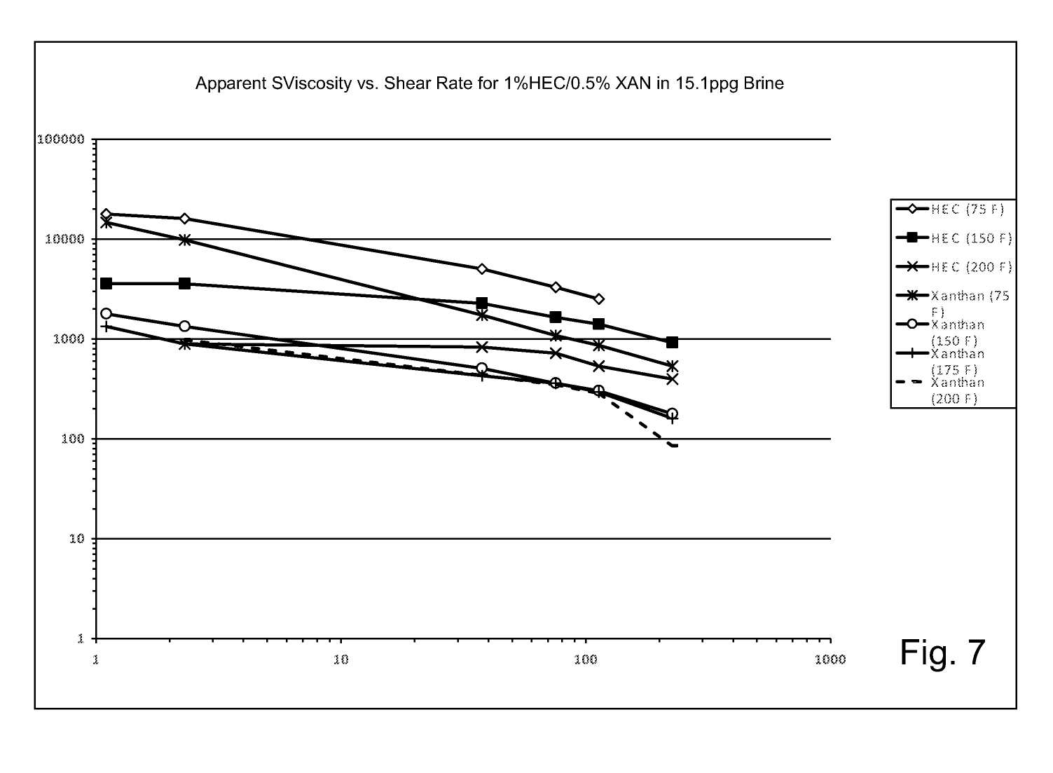

The data set forth in Tables 7 and 7.1 below and illustrated in FIG. 7 show the viscosity versus sheer rate relationship (using a Fan 35 viscometer) of a 1% solution of HEC and a 0.5% solution of xanthan in 15.1 ppg brine. In both cases, sheer thinning characteristics are maintained in the brine.

TABLE 7

| | | | | |
|---|---|---|---|---|
| | Shear | | Shear | |
| | Rate | | Stress | Apparent |
| R₁/B2 | sec⁻¹ | Reading | lbf/ft2 | Viscosity |

HEC 1%
75 deg F.

| | | | | |
|---|---|---|---|---|
| 3 | 1.1 | 21 | 0.441 | 17830 |
| 6 | 2.3 | 37 | 0.777 | 16047 |
| 100 | 37.7 | 189 | 3.969 | 5028.06 |
| 200 | 75.4 | 247 | 5.187 | 3289.635 |
| 300 | 113 | 283 | 5.943 | 2514.03 |

150 deg F.

| | | | | |
|---|---|---|---|---|
| 3 | 1.1 | 5 | 0.105 | 3566 |
| 6 | 2.3 | 9 | 0.189 | 3566 |
| 100 | 37.7 | 86 | 1.806 | 2273.325 |
| 200 | 75.4 | 124 | 2.604 | 1644.8175 |
| 300 | 113 | 159 | 3.339 | 1408.57 |
| 600 | 226 | 207 | 4.347 | 918.245 |

175 deg F.

| | | | | |
|---|---|---|---|---|
| 3 | 1.1 | 3 | 0.063 | 1783 |
| 6 | 2.3 | 5 | 0.105 | 1783 |
| 100 | 37.7 | 53 | 1.113 | 1390.74 |
| 200 | 75.4 | 86 | 1.806 | 1136.6625 |
| 300 | 113 | 110 | 2.31 | 971.735 |
| 600 | 226 | 135 | 2.835 | 597.305 |

200 deg F.

| | | | | |
|---|---|---|---|---|
| 3 | 1.1 | 1 | 0.021 | 0 |
| 6 | 2.3 | 3 | 0.063 | 891.5 |
| 100 | 37.7 | 32 | 0.672 | 829.095 |
| 200 | 75.4 | 55 | 1.155 | 722.115 |
| 300 | 113 | 61 | 1.281 | 534.9 |
| 600 | 226 | 90 | 1.89 | 396.7175 |

TABLE 7.1

| | | | | |
|---|---|---|---|---|
| | Shear | | Shear | |
| | Rate | | Stress | Apparent |
| R₁/B2 | sec⁻¹ | Reading | lb_{f}/ft² | Viscosity |

0.5% Xanthan Gum in 15.1 ppg
Room Temperature (75 deg F.)
75 deg F.

| | | | | |
|---|---|---|---|---|
| 3 | 1 | 17.50 | 0.3675 | 14709.75 |
| 6 | 2 | 23.00 | 0.4830 | 9806.5 |
| 100 | 38 | 66.00 | 1.3860 | 1738.425 |
| 200 | 75 | 82.00 | 1.7220 | 1083.1725 |
| 300 | 113 | 98.00 | 2.0580 | 864.755 |
| 600 | 226 | 121.00 | 2.5410 | 534.9 |

150 deg F.

| | | | | |
|---|---|---|---|---|
| 3 | 1 | 3.00 | 0.0630 | 1783 |
| 6 | 2 | 4.00 | 0.0840 | 1337.25 |
| 100 | 38 | 20.00 | 0.4200 | 508.155 |
| 200 | 75 | 28.00 | 0.5880 | 361.0575 |
| 300 | 113 | 35.00 | 0.7350 | 303.11 |
| 600 | 226 | 41.00 | 0.8610 | 178.3 |

175 deg F.

| | | | | |
|---|---|---|---|---|
| 3 | 1 | 2.50 | 0.0525 | 1337.25 |
| 6 | 2 | 3.00 | 0.0630 | 891.5 |
| 100 | 38 | 17.00 | 0.3570 | 427.92 |
| 200 | 75 | 28.00 | 0.5880 | 361.0575 |
| 300 | 113 | 34.00 | 0.7140 | 294.195 |
| 600 | 226 | 37.00 | 0.7770 | 160.47 |

200 deg F.

| | | | | |
|---|---|---|---|---|
| 3 | 1 | 1.25 | 0.0263 | 222.875 |
| 6 | 2 | 3.20 | 0.0672 | 980.65 |
| 100 | 38 | 17.20 | 0.3612 | 433.269 |
| 200 | 75 | 27.00 | 0.5670 | 347.685 |
| 300 | 113 | 33.00 | 0.6930 | 285.28 |
| 600 | 226 | 20.00 | 0.4200 | 84.6925 |

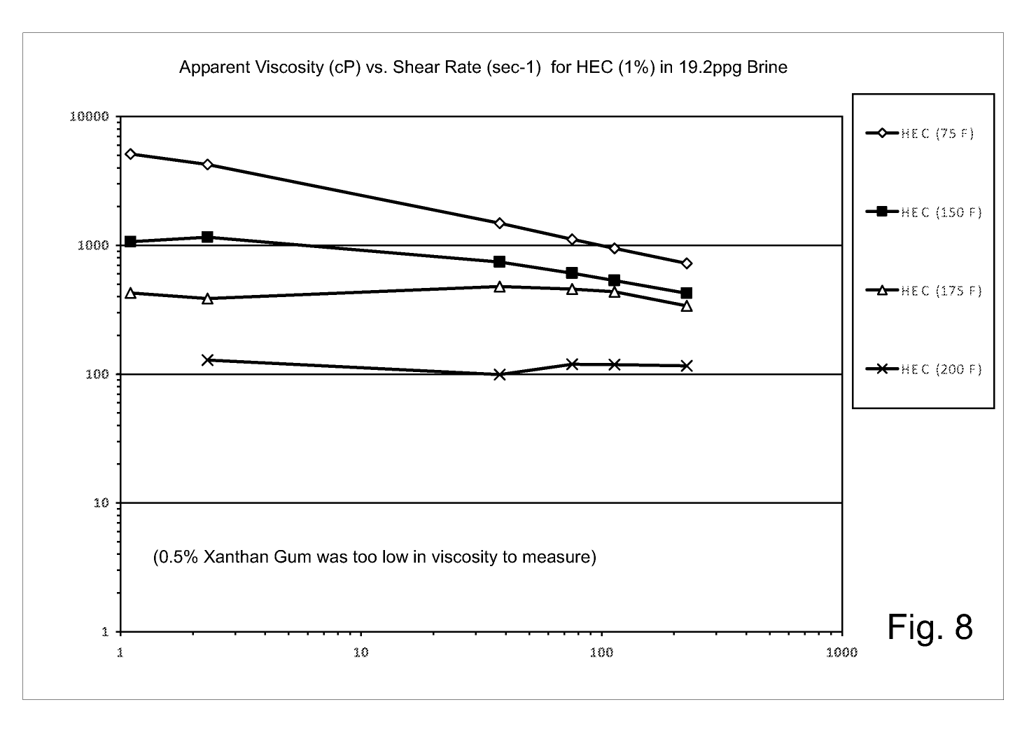

The data set forth in Table 8 below and illustrated in FIG. 8 show the viscosity versus sheer relationship (using a Fan 35 viscometer) of a 1% solution of HEC in 19.2 ppg brine over a temperature range of 75° F. through 200° F. Once again, HEC begins to loose sheer thinning characteristics at a temperature of 175° F.

TABLE 8

| | | | | |
|---|---|---|---|---|
| | Shear | | Shear | |
| | Rate | | Stress | Viscosity |
| R₁/B2 | sec⁻¹ | Reading | lb_{f}/ft² | (cP) 2 |

HEC (1%)
Room Temperature (75 deg F.)

| | | | | |
|---|---|---|---|---|
| 3 | 1 | 24 | 0.5040 | 5126.1736 |
| 6 | 2 | 33 | 0.6930 | 4249.5614 |
| 100 | 38 | 90 | 1.8900 | 1486.3569 |
| 200 | 75 | 112 | 2.3520 | 1115.1845 |
| 300 | 113 | 128 | 2.6880 | 947.9644 |
| 600 | 226 | 162 | 3.4020 | 723.3445 |

150 deg F.

| | | | | |
|---|---|---|---|---|
| 3 | 1 | 5 | 0.1050 | 1067.9528 |
| 6 | 2 | 9 | 0.1890 | 1158.9713 |
| 100 | 38 | 45 | 0.9450 | 743.1784 |
| 200 | 75 | 61 | 1.2810 | 607.3772 |
| 300 | 113 | 72 | 1.5120 | 533.2300 |
| 600 | 226 | 95 | 1.9950 | 424.1835 |

175 deg F.

| | | | | |
|---|---|---|---|---|
| 3 | 1 | 2 | 0.0420 | 427.1811 |
| 6 | 2 | 3 | 0.0630 | 386.3238 |
| 100 | 38 | 29 | 0.6090 | 478.9372 |
| 200 | 75 | 46 | 0.9660 | 458.0222 |
| 300 | 113 | 59 | 1.2390 | 436.9523 |
| 600 | 226 | 76 | 1.5960 | 339.3468 |

200 deg F.

| | | | | |
|---|---|---|---|---|
| 3 | 1 | 0 | 0.0000 | 0.0000 |
| 6 | 2 | 1 | 0.0210 | 128.7746 |
| 100 | 38 | 6 | 0.1260 | 99.0905 |
| 200 | 75 | 12 | 0.2520 | 119.4840 |
| 300 | 113 | 16 | 0.3360 | 118.4956 |
| 600 | 226 | 26 | 0.5460 | 116.0923 |

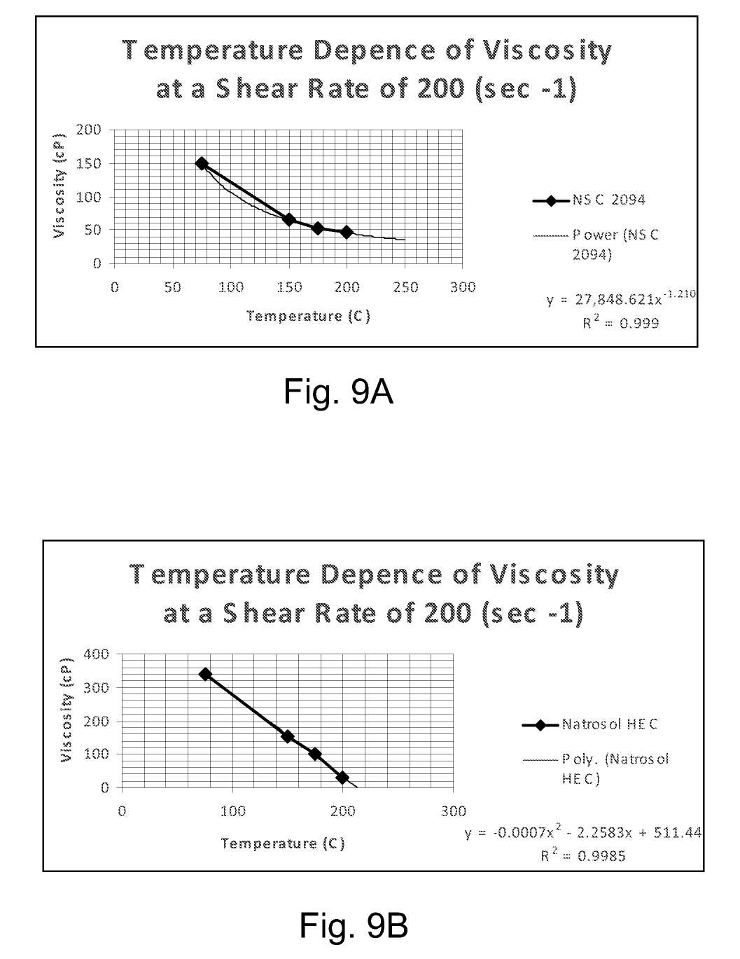

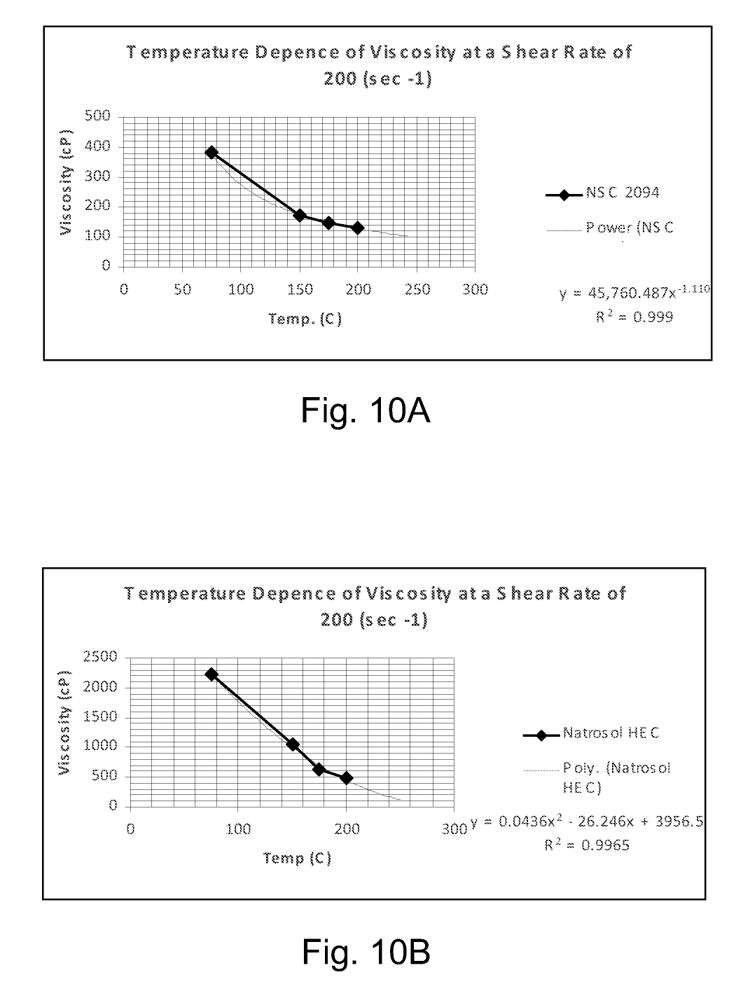

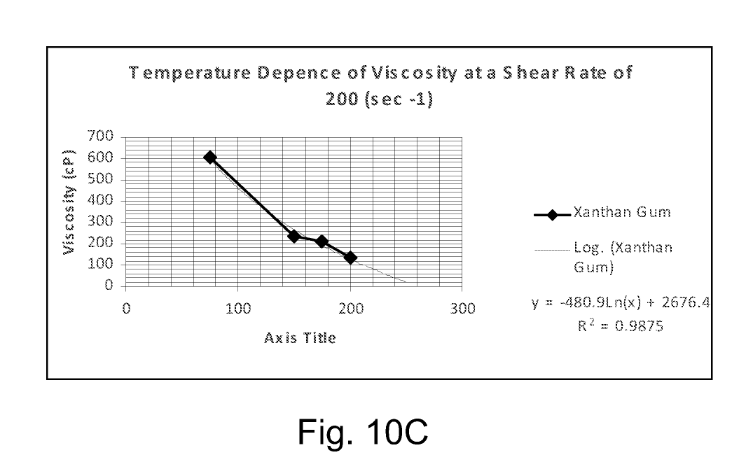

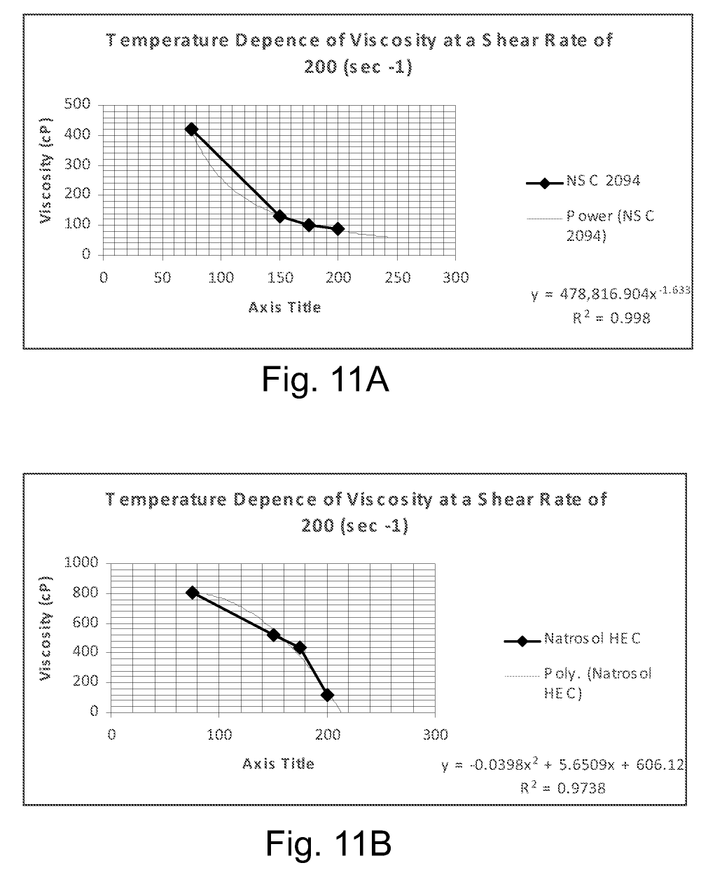

The data set forth in Tables 9A through 11B below and illustrated in corresponding FIGS. 9A through 11B (using a Fan 35 viscometer) compare the temperature dependence of the DADMAC/Allylamine copolymer at 2.5% and HEC at 1% in 11.6, 15.1 and 19.2 brine at a constant sheer rate of 200 sec⁻¹ over a temperature range of 75° F. though 200° F. Xanthan, at 0.5%, is also included in the comparison data of Tables 10C and corresponding FIG. 10C. The data show that viscosity/temperature relationship of the DADMAC/Allylamine copolymer initially curves in all brine concentrations, but begins to level out at approximately 150° F. Extrapolation shows the DADMAC/Allylamine copolymer to be stable approaching 300° F. Both xanthan and HEC have much steeper viscosity/temperature curves than the DADMAC/Allylamine copolymer and completely lose viscosity at approximately 200° F. in the 11.6 and 19.2 brines and at approximately 250° F. in the 15.1 brine.

TABLE 9A
DADMAC/Allylamine
Copolymer
At Shear Rate of 200 sec⁻¹ 200

| Viscosity | Temperature |
|---|---|
| 150.4174 | 75 |
| 65.44729 | 150 |
| 52.72614 | 175 |
| 46.54894 | 200 |

TABLE 9B
HEC
At Shear Rate of 100 sec⁻¹ 200

| Viscosity (cP) | Temperature |
|---|---|
| 338.7342 | 75 |
| 152.8713 | 150 |
| 102.5469 | 175 |
| 30.01233 | 200 |

TABLE 10A
DADMAC/Allylamine
Copolymer
At Shear Rate of 200 sec⁻¹ 200

| Viscosity (cP) | Temperature |
|---|---|
| 381.3307 | 75 |
| 173.5619 | 150 |
| 147.3299 | 175 |
| 129.6341 | 200 |

TABLE 10B
HEC
At Shear Rate of 200 sec⁻¹ 200

| Viscosity (cP) | Temperature |
|---|---|
| 2229.031 | 75 |
| 1043.426 | 150 |
| 634.7444 | 175 |
| 477.1264 | 200 |

TABLE 10C
XAN
At Shear Rate of 200 sec⁻¹ 200

| Viscosity (cP) | Temperature |
|---|---|
| 607.0796 | 75 |
| 233.0941 | 150 |
| 213.9755 | 175 |
| 133.8 | 200 |

TABLE 11A
DADMAC/Allylamine Copolymer 2094
19.2 ppg brine
At Shear Rate of 200 sec⁻¹ 200

| Viscosity (cP) | Temperature |
|---|---|
| 419.7073 | 75 |
| 129.1145 | 150 |
| 102.0773 | 175 |
| 86.86934 | 200 |

TABLE 11B
HEC
19.2 ppg brine
At Shear Rate of 200 sec⁻¹ 200

| Viscosity (cP) | Temperature |
|---|---|
| 810.3835 | 75 |
| 517.059 | 150 |
| 439.6098 | 175 |
| 120.2683 | 200 |

Polymerization

DADMAC Homopolymer. In a representative synthesis, to a one liter four-neck resin kettle equipped with stirrer, thermometer, condenser and purge tube, 2 moles DADMAC monomer and 0.3 mole % triallylamine based on total monomer-monomer concentration were added. The pH was adjusted to 7.0 with HCL. A sufficient quantity of water was added to adjust concentration of mixture to 55%. While stirring, the reaction system was purged with nitrogen and heated to 70 C. Nitrogen purge continued for 1 hr. Then, 12 mm of sodium persulfate was diluted with 20 ml deionized water. The reaction flask was removed from the heat source and 0.5 ml of the sodium persulfate solution was added to reaction flask. After a resultant exotherm subsided, the remaining persulfate solution was pumped into the reaction flask over 30 minute period. Subsequently, the reaction flask was held for 1 hr. at 70 C. Technically, the “DADMAC Homopolymer” is a copolymer of 99.7/0.3 mole % DADMAC/Triallylamine. The structure inducing agent (triallylamine in this case), which is present in each homopolymer or copolymer is not considered in the naming convention used in the present invention.

b 95/5 DADMAC/NVF Copolymer. Following the general methodology set forth in the previous example, 1.9 moles DADMAC and 0.1 mole NVF were added to the reaction flask. Replace 12 mm Sodium persulfate with 12 mm of VAZO 50 (a free radical source/initiator available from DuPont De Nemours and Company Corporation of Wilmington, Del.).

76/24 DADMAC/ALLYL Amine. Following the general methodology set forth in the previous examples, 1.52 moles DADMAC and 0.48 mole Allylamine were added to the reaction flask. The pH was adjusted to 5.0.

95/5 DADMAC/Trimethyl propyl acrylamide. Following the general methodology set forth in the previous examples, 1.9 mole DADMAC and 0.1 mole Trimethyl propyl acrylamide were added to the reaction flask.

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A method of modifying the rheological properties of a fluid, comprising: adding to the fluid at least one polymer that is the reaction product of at least one water soluble, allylic monomer and at least one structure inducing agent such that the polymer is adapted to increase the viscosity of the fluid and to impart non-Newtonian characteristic to the fluid.

2. The method of claim 1 wherein the fluid exhibits an n value of less than 1 upon addition of the polymer as determined by the equation τ=Kθⁿ, wherein τ is shear stress, θ is and shear rate and K is a flow consistency index.

3. The method of claim 1 wherein the structure inducing agent is a polyunsaturated compound.

4. The method of claim 3 wherein the polyunsaturated compound is selected from the group consisting of polyunsaturated acrylic amides, polyunsaturated acrylic esters, alkenylsubstituted heterocyclics, tri and tetra-allylic quaternary ammonium or amine compounds, and aldehydes.

5. The method of claim 1 wherein at least 0.05 mole % of structure inducing agent is used in synthesizing the polymer.

6. The method of claim 1 wherein the allylic monomer is an allylic quaternary ammonium compound, an allylic amine compound or a salt thereof.

7. The method of claim 1 wherein the allylic monomer is a diallylic monomer.

8. The method of claim 7 wherein the diallylic monomer is a diallylic quaternary ammonium compound, a diallylic amine compound or a salt thereof.

9. The method of claim 8 wherein the diallylic monomer is a diallylic quaternary ammonium compound.

10. The method of claim 9 wherein the diallylic monomer is a diallylic quaternary ammonium halide, a diallylic quaternary ammonium nitrate, a diallylic quaternary ammonium phosphate, a diallylic quaternary ammonium nitrite, a diallylic quaternary ammonium carbonate, a diallylic quaternary ammonium bicarbonate, a diallylic quaternary ammonium sulfate, a diallylic quaternary ammonium sulfite, a diallylic quaternary ammonium borate, or a diallylic quaternary ammonium carboxylate

11. The method of claim 10 wherein the diallylic monomer is a diallylic quaternary ammonium halide.

12. The method of claim 1 wherein the allylic compound is diallyldimethyl ammonium chloride, allyltrimethyl ammonium chloride, allylamine, a salt of allylamine, diallylamine or a salt of diallylamine.

13. The method of claim 1 wherein the polymer is the reaction product of at least one water soluble allylic monomer and at least one comonomer suitable to undergo radical polymerization.

14. The method of claim 13 the allylic monomer is present in at least 5 mole %.

15. The method of claim 13 wherein the at least one comonomer is an amine including at least one unsaturated group.

16. The method of claim 13 wherein the comonomer is at least one of an acrylic amide, a quaternary acrylic ester, a methacrylic ester, n-vinylpyrolidone, vinyl alcohol, a vinyl benzyl quaternary compound, a substituted vinyl benzyl quaternary compound, styrene, substituted styrene, a N-vinylformamide, or vinylamine.

17. The method of claim 1 wherein the fluid is a field fluid for use in hydrocarbon recovery.

18. The method of claim 17 wherein the fluid is acidic.

19. The method of claim 18 wherein the fluid has a pH of less than 1.

20. The method of claim 18 wherein the fluid comprises at least one of HCl or HF.

21. The method of claim 18 wherein the fluid comprises approximately 1 to 33 Wt % of an acid comprising at least one of HCl or HF.

22. The method of claim 3 wherein the fluid has a salinity of greater than 1000 mg/l ionized salts.

23. The method of claim 3 wherein the fluid has a salinity of at least 50,000 mg/l ionized salt.

24. The method of claim 3 wherein the fluid has a salinity of at least 100,000 mg/l ionized salt.

25. The method of claim 3 wherein the fluid has a salinity of at least 200,000 mg/l ionized salt.

26. A method of modifying the rheological properties of a hydrocarbon recovery fluid, comprising: adding to the fluid at least one polymer that is the reaction product of at least one water soluble, allylic monomer and at least one structure inducing agent such that the polymer is adapted to increase the viscosity of the fluid and to impart non-Newtonian characteristic to the fluid.

27. The method of claim 26 wherein the fluid is acidic.

28. The method of claim 27 wherein the fluid has a pH of less than 1.

29. The method of claim 27 wherein the fluid comprises at least one of HCl or HF.

30. The method of claim 26 wherein the fluid comprises approximately 1 to 33 Wt % of an acid comprising at least one of HCl or HF.

31. The method of claim 26 wherein the fluid has a salinity of greater than 1000 mg/l ionized salts.

32. The method of claim 26 wherein the fluid has a salinity of at least 50,000 mg/l ionized salt.

33. The method of claim 26 wherein the fluid has a salinity of at least 100,000 mg/l ionized salt.

34. The method of claim 26 wherein the fluid has a salinity of at least 200,000 mg/l ionized salt.

35. A fluid for use in hydrocarbon recovery comprising at least one polymer that is the reaction product of at least one water soluble, allylic monomer and at least one structure inducing agent such that the polymer is adapted to increase the viscosity of the fluid and to impart non-Newtonian characteristic to the fluid.

36. A hydrophilic polymer that is the reaction product of at least one water soluble, allylic monomer and at least one structure inducing agent such that the polymer is adapted to increase the viscosity of a fluid to which the polymer is added and to impart non-Newtonian characteristic to the fluid.

37. A method of recovering a hydrocarbon from a subterranean deposit of the hydrocarbon, comprising: modifying the rheological properties of a fluid having a salinity of greater than 1000 mg/l ionized salts and used in recovering the hydrocarbon by adding to the fluid at least one polymer that is the reaction product of at least one water soluble, allylic monomer and at least one structure inducing agent such that the polymer is adapted to increase the viscosity of the fluid and to impart non-Newtonian characteristic to the fluid.

38. The method of claim 37 wherein the fluid is an acid fluid, a thickening mud, a completion fluid or a workover fluid.

39. The method of claim 37 wherein the fluid has a salinity of at least 50,000 mg/l ionized salt.

40. The method of claim 37 wherein the fluid has a salinity of at least 100,000 mg/l ionized salt.

41. The method of claim 37 wherein the fluid has a salinity of at least 200,000 mg/l ionized salt.

42. The method of claim 37 wherein the fluid comprises at least one of a calcium salt or a zinc salt.
